(19) United States
(12) Patent Application Publication
(10) Pub. No.: US 2010/0084999 A1
(43) Pub. Date: Apr. 8, 2010

(54) Battery powered vehicular power generation system

(76) Inventor: Harry Wilson Atkinson, JR., Richmond, VA (US)

Correspondence Address: HARRY W. ATKINSON, JR., 2417 TRITON DRIVE, RICHMOND, VA, 23235, US

(21) Appl. No.: 12/285,478

(22) Filed: Oct. 7, 2008

(51) Int. Cl. H02P 1/00; B60K 1/00; H02J 7/14; B60L 11/00; H02J 7/00

(52) U.S. Cl. 318/139; 180/65.31; 320/123; 701/22; 320/137

(57) ABSTRACT

A battery powered system using a battery operated hydraulic pump to spin a weighted flywheel which is connected to a generator that generates electricity used to power all of the energy requirements for a vehicle. This system will use dual strings of batteries where one string of batteries can be recharging while the other string is supplying the power to the hydraulic pump.

### BACKGROUND OF THE INVENTION

As the world begins to use all of the natural petroleum readily available, the cost of oil increases as the supply decreases, this invention is designed to provide an alternate means of vehicular power using batteries instead of petroleum. In addition many of the suppliers take advantage of the reduced availability to charge premium prices for the oil. This invention will provide a means for powering all manner of vehicles through the use of batteries to supply the initial power.

One of the shortcomings with conventional battery vehicles is the ability for the power supply to provide sufficient energy to power the vehicle for extended periods of time. This invention uses the battery to power only the hydraulic pump which turns the flywheel producing the extra power needed for the vehicle. In this way the batteries need only supply the hydraulic pump which should extend the operating period to a time more in line with the operating time for a standard gasoline vehicle. For vehicles such as tractor trailers, buses, delivery vans, boats, etc. the battery strings can be made large enough to provide longer periods of operation.

Because the elements of this invention do not need to be physically aligned in a specific arrangement, they can be placed in the vehicle where they fit the best. For example, the flywheel can be at the very back end of a bus or under the bus where luggage is normally stored. The batteries can be placed where the gas tanks are on a tractor trailer or the electronic controller can be under the rear seat on a standard automobile. The only demand is for the generator to be in position where the flywheel can rotate it without any difficulty.

In order for this invention to perform flawlessly with the greatest efficiency, the shoe that fits on the edge of the flywheel where the thrust of the hydraulic pump is delivered must be of the closest tolerance. With the shoe fitting snuggly without physically touching the flywheel the force of the hydraulic fluid will be directed to vanes on the edge of the flywheel thus spinning the flywheel producing momentum which can be directed to the generator through either pulleys and belts; through geared wheels or direct coupled.

The power to the generator is supplied by the flywheel. The flywheel is weighted on the perimeter to provide more momentum as it spins. The radius of the flywheel being longer than the radius of the pulley; geared wheel or shaft provides greater power at the pulley, geared wheel or shaft to turn the generator than is supplied by the shoe and hydraulic pump. For example ten pounds of force applied at the shoe by the hydraulic pump to a flywheel with a radius of four feet will equal forty pounds of force to the pulley with a radius of one foot. This multiplication of power will allow for spikes in the demand for power as the system powers the vehicle. In addition, the greater force of the pulley can be used to add rotational speed to the generator by using a smaller pulley or geared wheel at the generator.

The battery strings are designed for the power to the hydraulic pump to last for at least four hours. The size of the battery strings to be calculated to provide the maximum amount of energy within the constraints of weight versus power supplied. A single string can consist of one battery or a plurality of batteries connected in series to supply the requisite power. To provide longer running time, more batteries can be added, especially in those vehicles such as trucks and boats where the weight may not adversely affect the performance.

Because this system is adaptable to any size or shaped vehicle, it could be designed and built large enough and powerful enough to provide energy sufficient to operate a train or ship. It would be especially desirable for large vehicles where both the noise and pollution would be eliminated.

### SUMMARY OF THE INVENTION

In accordance with the principles of the invention, a vehicle can contain within its shell all of the elements necessary to provide adequate power to motivate the vehicle as well as to power all of the ancillary equipment associated with said vehicle. This invention uses two strings of batteries, an electronic controller, a hydraulic pump, high pressure hose, a shoe to deliver the hydraulic fluid to the flywheel, weighted flywheel, pulleys or geared wheels, generator and battery chargers. These elements can be physically located in different parts of the vehicle and interconnected with hoses, electrical connections or pulleys. Because of the ability to locate the elements in different parts of the vehicle the need for special construction within the vehicle is greatly reduced.

In accordance with the principles of the invention, one of the strings of batteries will provide power through the electronic controller to the hydraulic pump. This string of batteries is designed to provide power to the hydraulic pump for an extended time, i.e. two to four hours before the electrical energy of the battery is depleted. Because there are two strings of batteries it is not necessary to completely drain a string of batteries. A preset threshold will be used to determine when to switch from one string of batteries to the other string of batteries thus eliminating the chance of ruining a string of batteries through total depletion of electrical energy.

In accordance with the principles of the invention, the electronic controller will select one of the two strings of batteries to be operational. The electronic controller will monitor the drain of the active string of batteries and through a predetermined level of depletion will automatically switch from the active string to the inactive string. Simultaneously a signal will be sent to the battery chargers to discontinue charging the inactive string and begin recharging the active string. Also simultaneously the inactive string will become the active string and the active string will become the inactive string. If in the operation of the vehicle both strings of batteries become depleted to a low level, the controller can add the two strings in series to provide emergency power until the operator can find a outside source for total recharging. During the operation of the vehicle, the electronic controller will continuously keep the operator informed on the condition of charge of the strings of batteries. In this way the operator can determine the length of time remaining for operation before outside charging may be necessary. It is the intent of this invention to provide the ability of the strings of batteries to recharge themselves while the vehicle is in the operational mode. It is also the intent that the use of two strings of batteries with one charging while the other is operating the vehicle, that the total operating time should exceed four hours of continuous operation.

In accordance with the principles of the invention, the strings of batteries operating through the electronic controller will operate a hydraulic pump. This pump will provide continuous pressure on the edge of the weighted flywheel by pumping hydraulic fluid under pressure through high pressure hose to the shoe delivering this force to the edge of the weighted flywheel. The amount of pressure will be calculated to provide sufficient force to the edge of the weighted flywheel to rotate the flywheel with enough power to turn the generator fast enough to generate enough power to operate the vehicle and all of its accessories. The hose will be larger at the hydraulic pump end and small at the shoe that delivers the fluid to the flywheel through the shoe. The fluid will be constricted at the end of the hose through an orifice that will increase the pressure to the vanes on the edge of the weighted flywheel. The fluid applied to the edge of the weighted flywheel will be expelled from the shoe and collected within the wrapping that will cover the weighted flywheel and its axel. The fluid will collect at the lowest point of the wrapping where it will be recycled to the hydraulic pump through a return hose. If the pump is located within the wrapping surrounding the weighted flywheel, then the hydraulic fluid may be recycled to the pump through a pick-up without the need for a return hose.

In accordance with the principles of the invention, the shoe that fits on the weighted flywheel will be constructed so as to fit snuggly to the flywheel without touching said flywheel. The closer the tolerance of the shoe to the flywheel the more of the hydraulic fluid pressure will be applied to the vanes on the flywheel resulting in more power to rotate the flywheel. The shoe will provide a secure connection to the high pressure hose and will contain an orifice which will reduce the size of the high pressure hose to increase the pressure applied to the vanes on the flywheel. The design of the shoe will closely replicate the curve of the flywheel in order to give the hydraulic fluid an area to apply the force of the fluid to the vanes on the flywheel before being expelled for reuse by the hydraulic pump.

In accordance with the principles of the invention, the weighted flywheel will be used to supply power to the generator through the use of hydraulic fluid pressure on the vanes located on the edge of the flywheel. The weighted flywheel will be as large as can be fitted into the space allowed within the vehicle. For example if the flywheel was located at the very rear of a city bus, the diameter of the wheel could exceed six feet. Conversely, if the flywheel is located under the hood of an automobile, the size of the diameter may be restricted to four feet or less. Actual size of the flywheel will depend on the space available as well as the amount of power needed by the generator to supply power to the vehicle.

The flywheel will be weighted on the perimeter in order to develop inertia that will maintain momentum as the flywheel rotates about its axel. On the outside of the perimeter of the flywheel will be vanes that the hydraulic fluid will push against to impel the flywheel in a rotational motion. The flywheel will rotate around an axel to which will be connected either a pulley or geared wheel. The difference between the radius of the flywheel and the radius of the pulley or geared wheel will multiply the force applied to the perimeter of the flywheel by the hydraulic pump to that of the pulley or geared wheel. For example if the radius of the flywheel is four feet and the radius of the pulley is one foot then if ten pounds of pressure is applied to the flywheel the pulley will realize four times the force or forty pounds of force available on the perimeter of the pulley. The forty pounds of force in this example would be available for the generator.

In accordance with the principles of the invention, the pulley or geared wheel affixed to the axel of the flywheel will transfer the power from the weighted flywheel to the generator. This transfer can be either from pulley to pulley using belt(s) or through geared wheels whose teeth mesh and rotate in opposite directions. The size of each pulley or geared wheel will be determined by the amount of power the generator requires or by the speed the generator needs to rotate in order to provide maximum power to the vehicle.

In accordance with the invention, the generator, or alternator or magneto will provide all the power the vehicle needs to motivate the vehicle as well as to provide power to all of the accessories within the vehicle. In addition to the power for the vehicle, the generator or alternator or magneto will also provide power to the battery charger(s) used to charge the stand-by string of batteries.

### DETAILED DESCRIPTION:

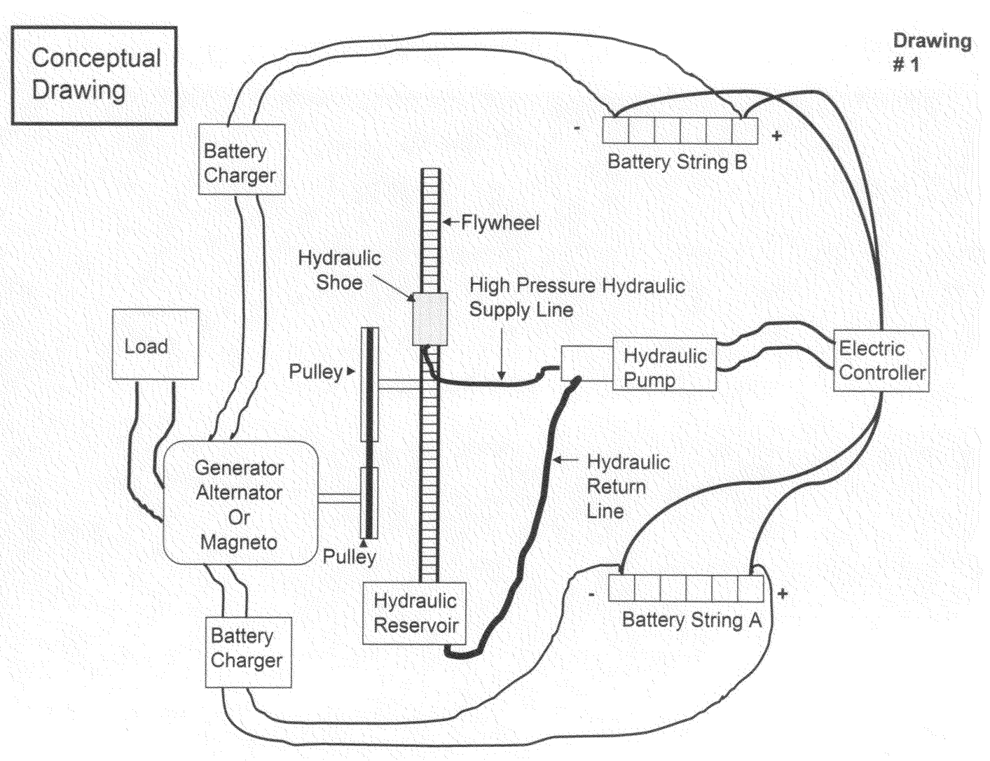

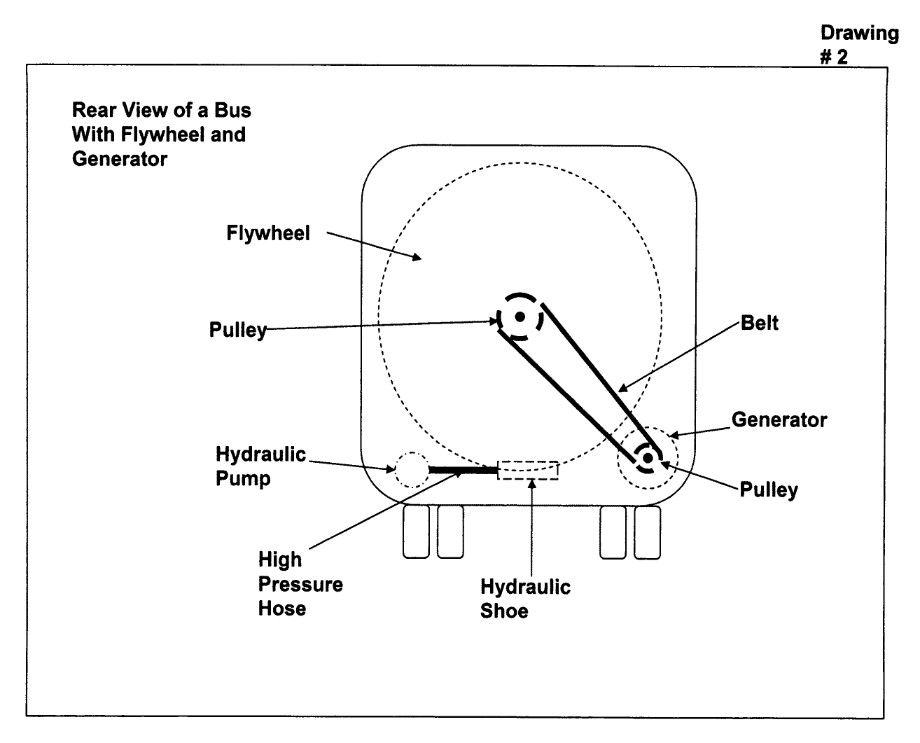

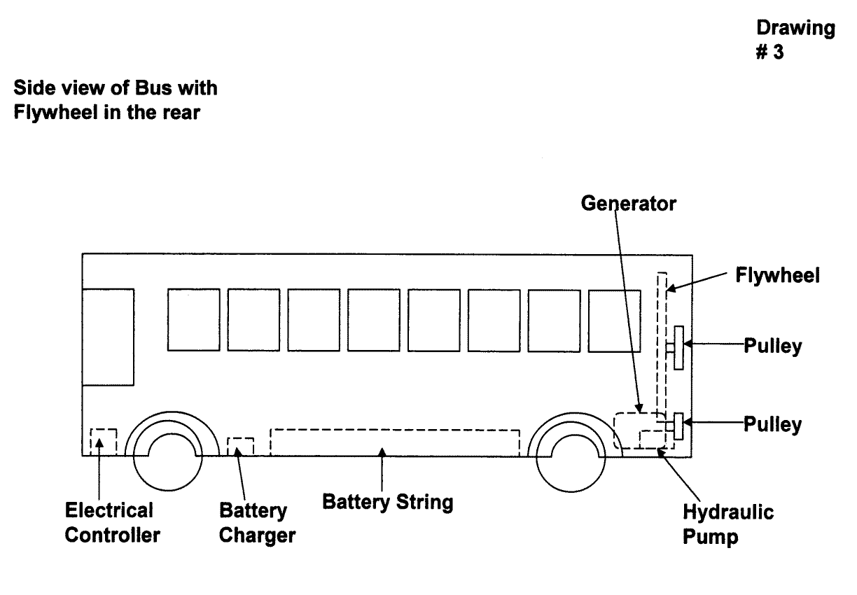

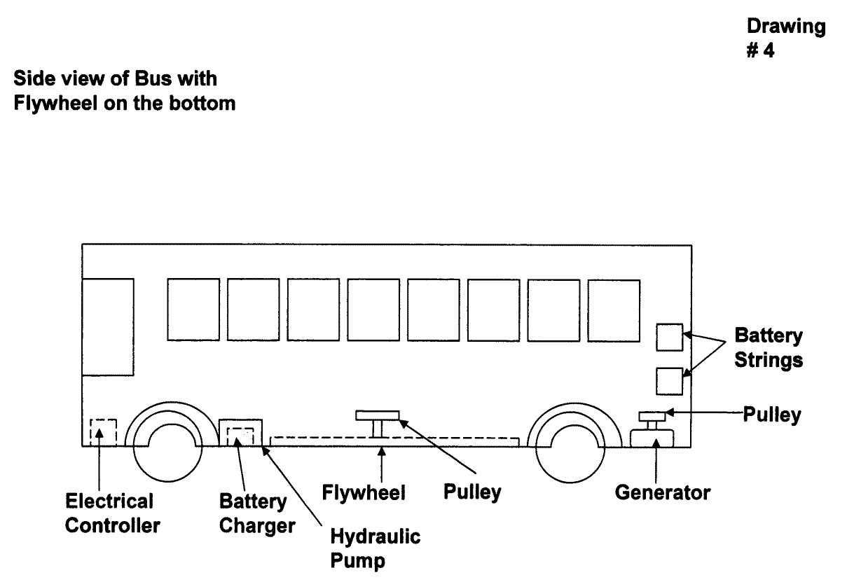

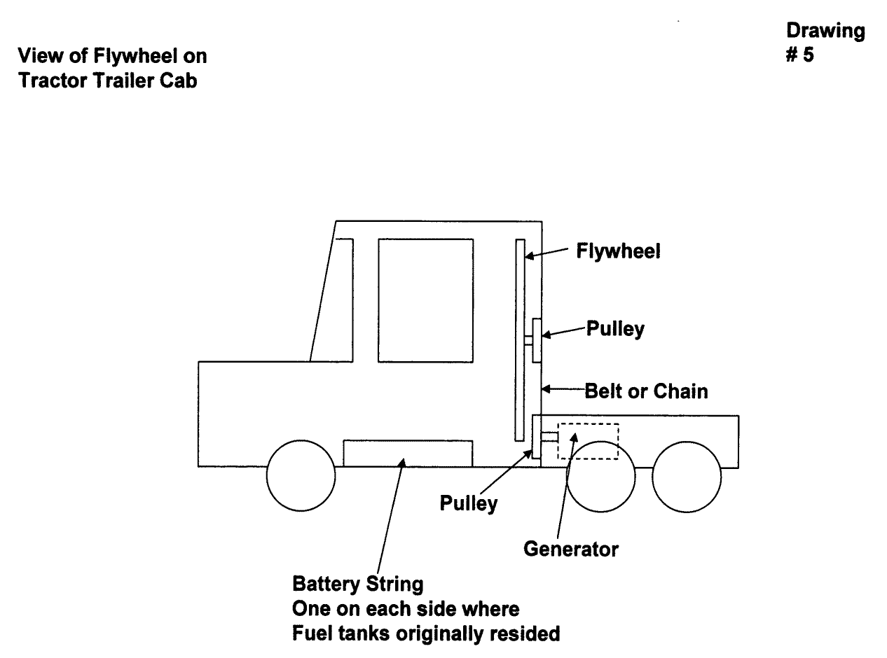

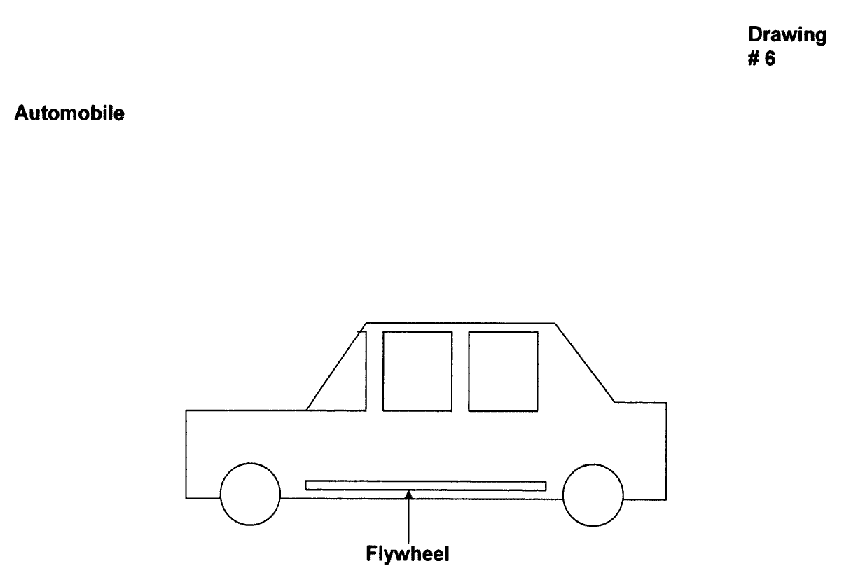

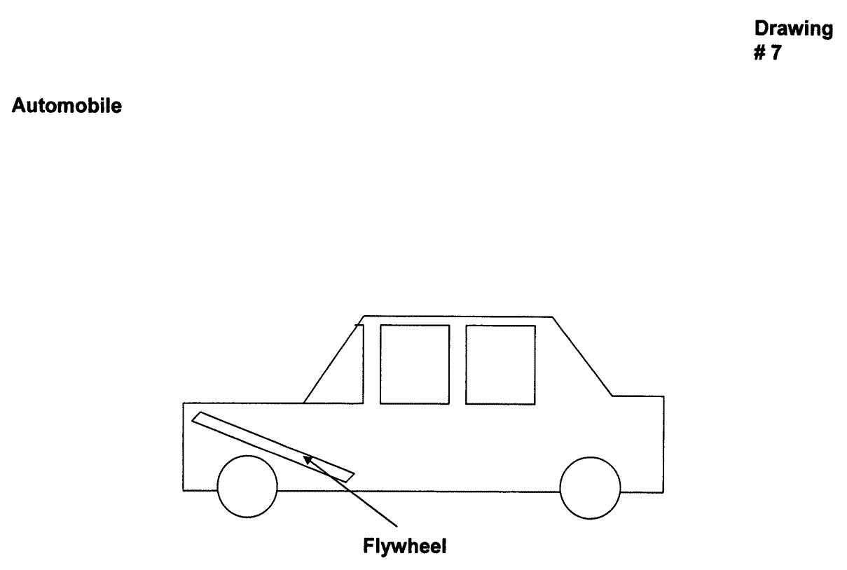

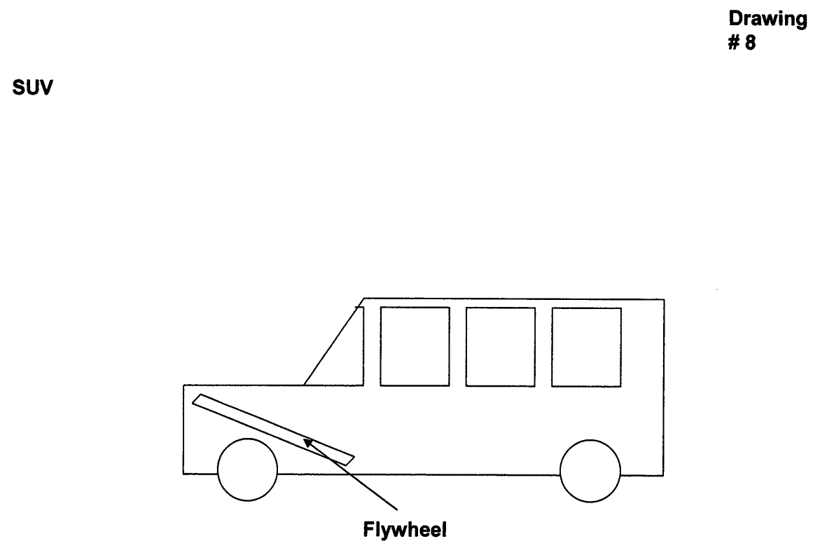

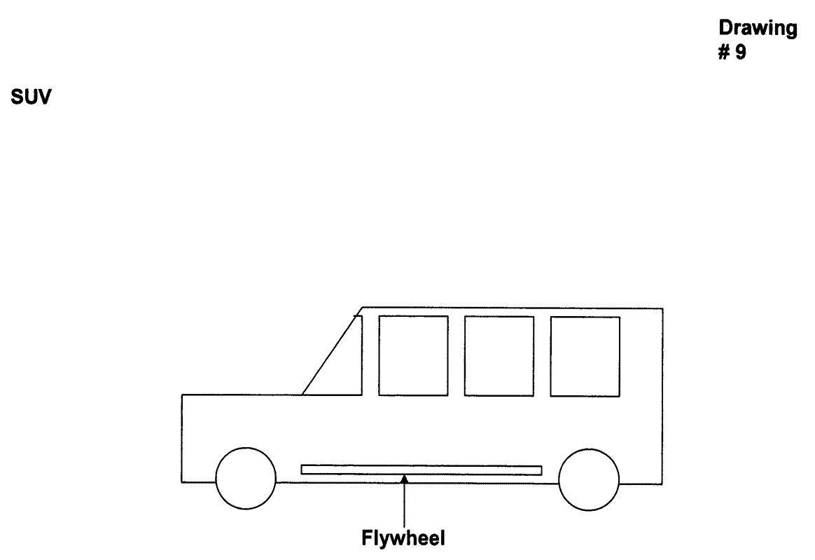

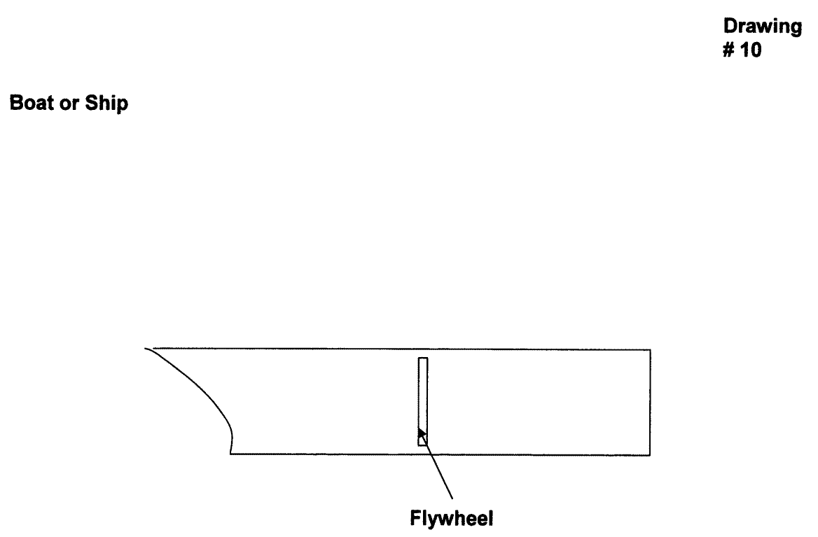

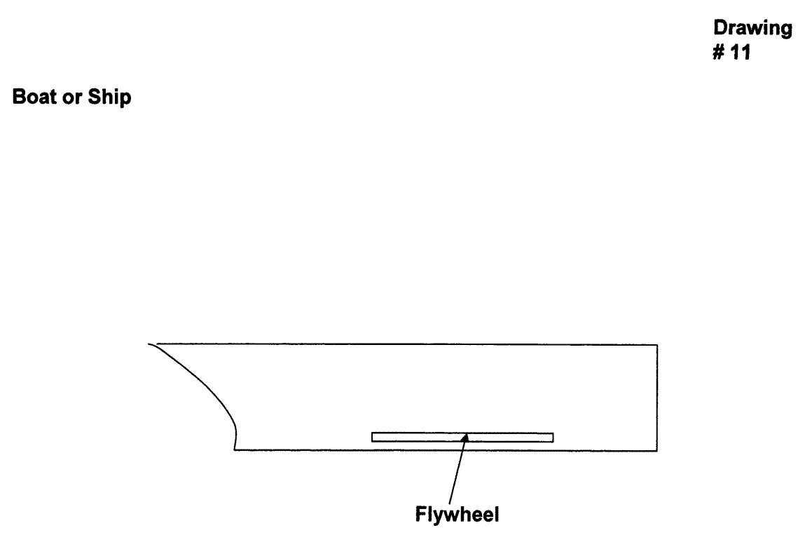

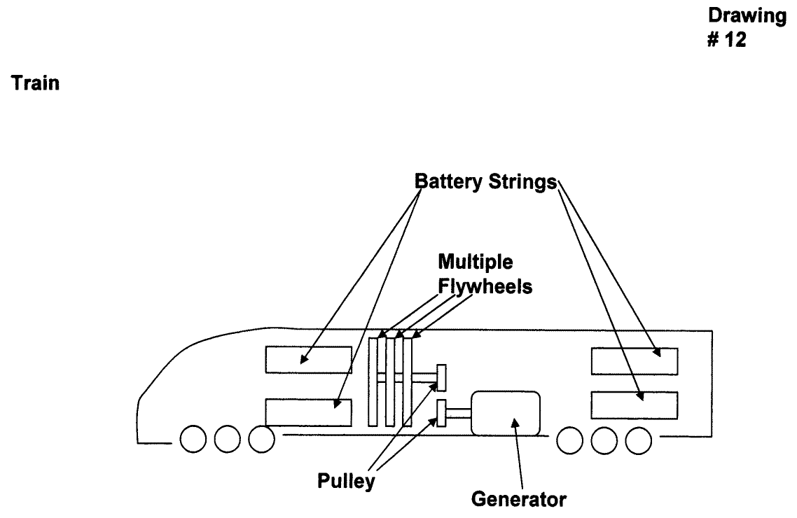

The present invention will be described to the accompanying drawings. FIG. 1 shows the conceptual design of the invention. This design shows pictorially the arrangement of the devices in relation to each other and not the actual physical arrangement which will depend on the space available on any specific vehicle. All of the various components of the invention can be located anywhere within a specific vehicle with the exception of the flywheel and the generator. These two must be in close proximity of each other in such a relationship that the rotational drive of one can be easily transferred to the other.
1. The source of power for this invention is battery power. The batteries for the invention will be arranged in two or more strings that are interconnected through an electrical controller which manages the electrical output from the batteries to the hydraulic pump. The batteries are to be arranged in strings of one or more batteries that provide sufficient power to operate a hydraulic pump at maximum capacity for four or more hours continuously. The batteries shall be rechargeable with multiple recharging capability. The size and capacity of the batteries will depend directly on the expected output. Optimum battery output will be expended without harm to the string of batteries before switching to the secondary string of batteries.
2. In reference to 1 above, the battery strings will be separately coupled to the electrical controller using electrical wiring of sufficient size to allow maximum transfer of power from the batteries to the hydraulic pump.
3. In reference to 1 above, the electrical controller will pass the power from the batteries to the hydraulic pump through a connection that allows the maximum power transfer.
4. In reference to 1 above, the electrical controller will monitor the output from the active string of batteries to determine the drain on said string of batteries.
5. In reference to 1 above, the drain of the string of batteries will be preset to allow maximum drain before switching, once this level has been attained, the electrical controller will automatically switch to the stand-by string of batteries.
6. In reference to 1 above, the electrical controller once the switch has been made from active to stand-by for the battery string, will automatically take the active string and make it the stand-by string.
7. In reference to 1 above, the electrical controller will signal the battery chargers that the strings have been switched and for the stand-by string of batteries to become the active string of batteries and vice versa. Once this has been changed the battery charger for the active string of batteries will begin charging and the battery charger for the stand-by string of batteries will stop charging and go into active mode.
8. In reference to 1 above, should both of the battery strings fall below the acceptable level of charge during operation of the vehicle, the electrical controller will be able to arrange these in series to work cooperatively allowing the vehicle to operate for a short duration in the emergency mode.
9. In reference to 8 above, the electrical controller will send a warning to the operator that the batteries are in depleted condition and that recharging must begin at the earliest time.
10. In reference to 1 above, the active string of batteries, through the electrical controller will provide the power to operate the hydraulic pump.
11. The purpose of the hydraulic pump is to provide the force to turn the flywheel by applying the power from the hydraulic fluid to the vanes located on the edge of the flywheel.
12. In reference to 11 above, the hydraulic pump will collect the hydraulic fluid for recycling through the pump from the reservoir at the lowest point of the shell enclosing the flywheel.
13. In reference to 11 above, the hydraulic pump will deliver the hydraulic fluid under pressure to the shoe located in close proximity to the flywheel.
14. In reference to 11 above, the hydraulic pump will force the hydraulic fluid through a restricted orifice in the shoe therefore increasing the pressure on the vanes of the flywheel.
15. In reference to 11 above, the hydraulic pump will recover the hydraulic fluid from the flywheel once the fluid has passed through the shoe and forced the flywheel to rotate past the shoe sufficient enough to allow the fluid to fall into the reservoir at the lowest point.
16. In reference to 11 above, the hydraulic pump may recapture the hydraulic fluid through a hose to the reservoir or may be co-located within the reservoir where the fluid can be recaptured through a pick-up as a part of the hydraulic pump.
17. In reference to 11 above, the high pressure hose from the hydraulic pump to the shoe will be coupled on either end with sufficient devices to allow for the maximum pressure delivery from the pump to the shoe.
18. The shoe that delivers the hydraulic fluid to the flywheel will be milled to the closest tolerance that matches the curvature of the flywheel. This tolerance will allow the shoe to deliver the maximum power to the vanes on the edge of the flywheel with the minimum of loss due to fluid spraying away from the vanes.
19. In reference to 18 above, the shoe will have overlap on each side of the shoe that extend down the side of the flywheel to help prevent spray from the hydraulic fluid as it presses against the vanes of the flywheel.
20. In reference to 19 above, the overlap down the sides of the flywheel by the shoe will be of the closest tolerance to gain the most effective pressure applied to the vanes of the flywheel.
21. In reference to 18 above, the shoe will have one or more internal orifices that will be larger on the intake end and smaller on the delivery end to allow the fluid to build up additional pressure before delivery to the vanes of the flywheel.
22. In reference to 18 above, the shoe will be of sufficient length around the circumference of the flywheel to give the hydraulic fluid the ability to dissipate the power contained in the pressurized hydraulic fluid before being expelled into the shell surrounding the flywheel.
23. A flywheel will provide the ability for the hydraulic fluid from the hydraulic pump to be transferred in rotational motion. This flywheel will be weighted on the circumference and contain vanes on the outer edge to accept the hydraulic fluid from the hydraulic pump.
24. In reference to 23 above, the weight applied to the circumference will be calculated to offer the maximum power transfer based on the size of the flywheel and the amount of pressure supplied by the hydraulic pump.
25. In reference to 23 above, the vanes on the circumference of the flywheel will be arranged to accept the most pressure supplied by the hydraulic pump through the shoe.
26. In reference to 25 above, the vanes will be perpendicular to a tangent at any point on the circumference of the flywheel in order to provide a 90 degree angle for the hydraulic fluid to be applied with the maximum amount of force.
27. In reference to 23 above, the flywheel will be surrounded with a shell that will prevent the hydraulic fluid from escaping.
28. In reference to 23 above, the flywheel will have an axel in the center that will be affixed to one side of the shell and extend through the shell on the opposite side.
29. In reference to 28 above, the axel will be affixed by means of bearings that will allow the flywheel to rotate with the least amount of friction.
30. In reference to 28 above, the bearings holding the axel that protrudes out of the shell will not only reduce friction but will prevent fluid from escaping the shell. It is important that the flywheel be allowed to rotate as freely as possible in order that the force applied to the vanes on the circumference of the flywheel be transferred to the generator.
31. In reference to 28 above, attached to the axel that protrudes from the shell will be a pulley or geared wheel that will be used to transfer the rotational force applied to the circumference of the flywheel to the generator.
32. In reference to 23 above, the size of the pulley or geared wheel will be calculated to provide the most force to the generator based on the amount of force needed to operate the vehicle and the amount of force available from the hydraulic pump.
33. In reference to 23 above, the difference between the radius of the flywheel and the radius of the pulley or geared wheel will be directly correlated to the amount of pressure applied to the vanes of the flywheel and the amount of power available to the generator. For example, if the radius of the flywheel is four time greater than the radius of the pulley or geared wheel, then the amount of power available to the generator will be four times the amount of pressure applied to the vanes of the flywheel.
34. The pulley or geared wheel will be used to transfer the force applied to the vanes of the flywheel to the generator where the resulting electrical EMF will be available for the vehicle to use for motive force as well as power accessories.
35. In reference to 34 above, the pulley can be a single channel pulley with a single belt used for transferring the power to the generator.
36. In reference to 34 above, the pulley can be multiple channels with multiple belts transferring the power to the generator. In this case, the belts provide a redundancy if one belt breaks then the transfer of power is continued as long as there are belts left on the pulley.
37. In reference to 34 above, the pulley and belt can be toothed so the belt fits into teeth on the pulley preventing slippage and transferring more power to the generator. This teeth arrangement will allow for surges in power requirements from the vehicle to the generator to be met without any slippage reducing the power available to the vehicle.
38. In reference to 34 above, the pulley allows the generator to be located at a distance from the axel of the flywheel because of the length of the belts available for use. This arrangement gives the designer more flexibility to place the generator within the vehicle and still provide the power necessary.
39. In reference to 34 above, a geared wheel can be used on the axel to transfer power to the generator.
40. In reference to 34 above, the geared wheel will interlock with a geared wheel of the same tooth size and configuration to be able to smoothly transfer the power to the generator.
41. In reference to 34 above, the physical proximity of the geared wheel on the end of the axel of the flywheel and the geared wheel on the generator will have to be arranged so they inter connect easily.
42. The generator can be either, a generator, an alternator or a magneto. The ability of the generator to provide the electrical potential to operate the vehicle and all of its accessories is the goal of this patent. The operation of the vehicle includes the ability of the vehicle to move under its own power from place to place using the power supplied by the generator connected to the flywheel and powered by the battery operated hydraulic pump.
43. In reference to 42 above, the generator will also supply power to the battery charger(s) that will charge the stand-by string of batteries.
44. In reference to 42 above, the generator will be of sufficient size to allow for all of the power demands for the vehicle to be supplied at something less than 100% of the power generated. This will allow the generator to work at high efficiency without overloading the system during power surges.
45. Battery charger(s) are an integral part of this invention. The use of battery charger(s) will allow the power supplied by the active string of batteries to be applied to the stand-by string of batteries thus keeping a string at full power in readiness.
46. In reference to 45 above, the battery charger may be singular or plural depending on the amount of charging required by the strings of batteries.
47. In reference to 45 above, if a single battery charger is employed, this charger will be available for the stand-by string of batteries at all times.
48. In reference to 47 above, when the strings of batteries are switched from active to stand-by and vice versa, the battery charger will switch accordingly.
49. In reference to 45 above, if two chargers are used, one for each string of batteries, the battery charger for the string of batteries in the active mode will be on stand-by until that string of batteries becomes inactive then the charger will become active and vice versa with the other string of batteries and charger.
50. In reference to 45 above, when two battery chargers are used, the chargers can both be used to charge their respective strings of batteries at the same time when the system is shut down and the power to the battery chargers comes from an external source.
51. In reference to 47 above, when only one battery charger is used, it can be arranged to supply charging to both strings of batteries when the system is shut down and the power to the batter charger is from and external source.

I claim as my invention:

1. In combination in a vehicle, either a land vehicle with a plurality of wheels or water vehicle using propeller(s) or water jet(s), a battery powered hydraulic pump that spins a weighted flywheel connected to a generator with sufficient speed to generate enough electricity to power all of the requirements for the vehicle including powering the wheels and/or the propeller or water jet.

2. The flywheel being encased in a shell to allow the fluid from the hydraulic pump to be captured and recycled.

3. The output of the generator to supply all power for the vehicle and provide electricity to recharge the stand-by string of batteries. The term generator for the purposes of this invention can be either a generator, a magneto or an alternator.

4. The string of batteries may be a singular battery or a plurality of batteries depending on the needs of the hydraulic pump. It is the intent of this invention to operate the system for a minimum of four hours continuously using only battery power.

5. The system will use an electronic controller to determine the level of charge for the operating string of batteries and automatically switch to the stand-by string when the level of charge sinks below a predetermined level. If in the use of this system the level of both the stand-by string of batteries and the active string of batteries falls below normal operating level, the electronic controller will configure the two strings to act as one and provide emergency power to allow the operator sufficient time to get to a source for recharging.

6. An external electrical connection will be provided to allow charging of the strings of batteries from a standard receptacle.
